(19) United States
(12) Patent Application Publication
(10) Pub. No.: US 2010/0050182 A1
(43) Pub. Date: Feb. 25, 2010

(54) PARALLEL PROCESSING SYSTEM

(75) Inventors: Alexander Mintz, Livingston, NJ (US); Andrew Kaplan, River Edge, NJ (US)

Correspondence Address: DAVIS WRIGHT TREMAINE LLP/Los Angeles, 865 FIGUEROA STREET, SUITE 2400, LOS ANGELES, CA, 90017-2566, US

(73) Assignee: ZIRCON COMPUTING LLC, Wayne, NJ (US)

(21) Appl. No.: 12/531,152

(22) PCT Filed: Dec. 3, 2007
(86) PCT No.: PCT/US07/86287

§ 371 Date: Sep. 14, 2009

(51) Int. Cl. G06F 15/76; G06F 9/46; G06F 9/02

(52) U.S. Cl. 718/105; 712/30; 712/E09.002

(57) ABSTRACT

A system for processing a user application having a plurality of functions identified for parallel execution. The system includes a client coupled to a plurality of compute engines. The client executes both the user application and a compute engine management module. Each of the compute engines is configured to execute a requested function of the plurality of functions in response to a compute request. If, during execution of the user application by the client, the compute engine management module detects a function call to one of the functions identified for parallel execution, and the module selects a compute engine and sends a compute request to the selected compute engine requesting that it execute the function called. The selected compute engine calculates a result of the requested function and sends the result to the compute engine management module, which receives the result and provides it to the user application.

### BACKGROUND OF THE INVENTION

1. Field of the Invention

The present invention is directed generally to a system configured to execute functions called by an application in parallel.

2. Description of the Related Art

Many businesses, such as financial institutions, pharmaceutical companies, and telecommunication companies, routinely execute computer-implemented applications that require the execution of functions that could be executed in parallel rather than serially. For example, many financial institutions execute financial Monte Carlo models that iteratively model the total future value of financial instruments held in a portfolio, and then examine the distribution of the results of each iteration. The increases and decreases of the value of the portfolio may be modeled using one or more separate market models. If the predicted gain or loss of the value of the portfolio is of interest, the distribution of the difference between the present value of the portfolio and its predicted value may be examined. Because each of the iterations is independent of the other iterations, all of the iterations can be executed at the same time in parallel. Monte Carlo models may be used to calculate risk measures for the portfolio such as a Value-at-Risk (“VaR”) metric. The VaR may be determined by selecting a particular percentile (e.g., 95^{th}) of the distribution as a confidence level, the VaR being the predicted gain or loss of the value of the portfolio at that the selected percentile.

Additional examples of applications that include functions that may be executed in parallel include historical evaluations of financial information, real time decision making applications based on algorithmic feedback (e.g., market making, electronic strategy arbitrage, and the like), image processing (e.g., medical MRI, video animation, and the like), calculating numerical solutions for differential equations, statistical analysis, pattern matching, and the like. As is apparent to those of ordinary skill in the art, each of the examples provided above may be considered a time critical application because the speed at which the application can be executed determines the precision of the result(s) and the number of scenarios that can be evaluated. Further, each of the examples provided above may include large amounts of data. The repetitive computation of large data sets may also be considered an application that include functions that may be executed in parallel.

Because of the need for parallel processing in many industries, many researchers and companies have focused on methods and techniques of analyzing algorithms and software to determine which functions and processes could be executed in parallel. Consequently, many methods of parallelizing software exist in the art.

Further, many implementations of parallelized hardware also exist. These implementations include computer clusters (a plurality of computers networked together that function like a single computer), computer grids, computers configured to include multiple processors, multi-core processors, virtualized environments, and the like.

An implementation of an application that executes functions in parallel requires both load balancing between the processor(s) and monitoring to ensure (1) a response was received and (2) received responses are provided to the application in the proper order to facilitate the completion of the parallel functions at substantially the same time. As is apparent to those of ordinary skill, many applications having functions that are executable in parallel also have subsequent operations that require all of the results of the parallel functions before continuing. Therefore, all responses must be received or the application cannot continue processing. For this reason, if a response is not received, it is desirable to re-execute the function from which a response was not received. It is also desirable to determine the response is not received within a reasonable amount of time to avoid unnecessarily delaying the completion of the application.

Any parallel processing system is only as fast as the process or combination of processes that require the most time to complete. In computing environments in which a function will require different amounts of time to complete depending upon which component of the system executes the function, managing the distribution of the functions to the various components may be critical to the overall performance of the system. It is desirable to avoid overloading some processors while idling others.

Some computer clusters include computers having processors with differing clock rates. Further, communication delays involved in sending and receiving information to and from the computers in the cluster may vary. Therefore, it is desirable to consider different performance capabilities of the individual computers as well as other system delays when balancing the load across the computer cluster.

While a new computer cluster may be constructed using identical computing hardware, doing so may be expensive. Further, such machines are likely to be dedicated to executing only the parallel functions. Therefore, because of the costs involved, it is desirable to use a company's existing computer hardware (including heterogeneous computing devices coupled to an existing network) instead of purchasing new dedicated computing devices.

Additionally, the various functions called by an application may require differing amounts of time to execute, even if executed on identical hardware without communication delays. Therefore, a parallel processing system capable of load balancing the execution of heterogeneous functions (i.e., functions requiring differing amounts of time to execute) is also desirable.

Many prior art computer cluster implementations include a gateway or intermediate server located between the computer requesting the execution of one or more functions and the clustered computers. The intermediate server is responsible for managing and load balancing all of the computational requests sent to the clustered computers. If the intermediate server fails, the entire cluster is idled and the results of the computational requests sent by the users may be lost. In other words, the entire cluster has a single point of failure, the intermediate server.

While heterogeneous hardware and operating software create challenges to parallel processing, most computing environments are heterogeneous. The prior art lacks methods of executing parallelized software on parallelized hardware, particularly when that hardware is heterogeneous or the connections between the processors introduce non-uniform delays. The heterogeneous environment is particularly difficult to manage because the results of the computations may not arrive in the order the requests were sent, which creates delays and idles hardware. Uneven loading of the processors may further exacerbate this problem.

Many software packages, including software libraries, have functions identified for parallel execution. However, the developers of many of these software packages consider their code and algorithms proprietary and do not wish to make the source code available to a user. Therefore, a need exists for a method of distributing the execution of the functions identified for parallel execution that does not require access to the source code. A further need exists for a method of configuring the software package for parallel distribution that does not require expert programming knowledge. A method of configuring a system for parallel execution of functions that is readily scalable (e.g., allows new processors, computers, and the like to readily added to the system) is also desirable. The present application provides this and other advantages as will be apparent from the following detailed description and accompanying figures.

### SUMMARY OF THE INVENTION

Aspects of the invention include a system for processing a user application having a plurality of functions identified for parallel execution. The system includes a client computing device coupled to a plurality of compute engines. The client computing device has a memory storing the user application and a compute engine management module, and a processing unit configured to execute the user application and the compute engine management module. Each of the compute engines is configured to execute the plurality of functions and to execute a requested function of the plurality of functions in response to a compute request. If, during the execution of the user application by the processing unit, the compute engine management module detects a function call to a one of the plurality of functions, the compute engine management module instructs the processing unit to select a compute engine from the plurality of compute engines. Then, the compute engine management module instructs the processing unit to send a compute request to the selected compute engine requesting execution of the function (as the requested function). The selected compute engine executes the requested function and sends a result back to the client computing device. The compute engine management module instructs the processing unit to receive the result, and to provide the result to the user application.

Each of the compute engines may be configured to send a message to the client computing device informing the compute engine management module of the existence of the compute engine. In response to receiving a message from a compute engine, the compute engine management module may instruct the processing unit to add a record for the compute engine to a data structure identifying compute engines available for processing compute requests. In such embodiments, when the processing unit selects a compute engine, the compute engine management module instructs the processing unit to select a compute engine from the data structure.

The compute engine management module may be configured to detect a compute request has expired by detecting the result has not yet been received and a predetermined time period has elapsed since the compute request was sent. If the compute request has expired, the compute engine management module may instruct the processing unit to select a different compute engine to which to send the compute request. If the compute request has expired, the compute engine management module may to instruct the processing unit to delete the record for the selected compute engine from the data structure.

The compute engine management module may be configured to instruct the processing unit to construct a load balancing table which includes a record for each compute engine. Each record in the load balancing table may include a compute engine identifier associated with a compute engine and a capacity indicator indicating capacity available on the compute engine to process a new compute request. The compute engine management module may instruct the processing unit to update the record for the selected compute engine after the result of the function called is received based at least in part on an amount of time that elapsed between when the compute request was sent and when the result was received. In such embodiments, when the processing unit selects the compute engine from the plurality of compute engines, the compute engine management module instructs the processing unit to select the compute engine from the plurality of compute engines based at least in part on the capacity indicators in the load balancing table. Each of the compute engines may be configured to inform the compute engine management module of capacity available on the compute engine to process a new compute request, and the compute engine management module may be configured to instruct the processing unit to select the compute engine based at least in part on the available capacity of the plurality of compute engines provided by each of the compute engines.

During execution of the user application by the processing unit, the user application makes function calls to the plurality of functions in a predetermined order, and the compute engine management module may be configured to determine whether the result of the function called was received ahead of a result of a previously called function in the predetermined order. If the result of the function called was received ahead of the result of the previously called function in the predetermined order, the compute engine management module may wait until the result of the previously called function is received and provide the result of the previously called function to the user application before the result of the function called.

Aspects of the invention include a method of configuring the system to process the user application. The method includes creating a plurality of new functions (e.g., zfunctions) by creating a new function corresponding to each original function of the plurality of original functions. Each original function may include executable object code and a function definition, which are used to create the corresponding new function. Then, the user application is modified to replace each function call to an original function with a function call to a new function. Each of the new functions identifies the corresponding original function to the client computing device when the new function is called by the user application. Next, the plurality of compute engines of the system are created and installed. After installation, each of the plurality of compute engines, sends a message to the client computing device indicating the compute engine is available to receive a compute request.

After the system is configured, the modified user application is executed on the client computing device. During execution of the modified user application and after a new function has identified a corresponding original function to the client computing device, a compute request is sent to a compute engine that has indicated it is available to receive a compute request.

The system may further include a license server. During installation of the plurality of compute engines, each compute engine may be required to register with a license server. The license server is configured to allow only a predetermined number of compute engines to register, and if more than the predetermined number of compute engines attempt to register, installation of those compute engines is prevented.

The client computing device may execute a plurality of user applications, each having function calls to one of a plurality of libraries. Each of the libraries includes a different library identifier and a plurality of functions that may be executed in parallel. For each library, a corresponding plurality of compute engines each having the library identifier may be created. The client computing device has a data structure storing for each compute engine, the library identifier and the compute engine identifier of the compute engine, and is configured to use the data structure to select a compute engine to which to send each function call raised by the plurality of user applications. After installation, each of the compute engines may send a message including the library identifier and the compute engine identifier to the client computing device, which the client computing device uses to add the compute engine to the data structure.

In some embodiments, each function in the plurality of libraries has a different function identifier. In such embodiments, for each library, a corresponding plurality of compute engines is created. Each compute engine in a particular plurality of compute engines has the function identifiers of the functions in the library. For each compute engine, the data structure of the client computing device stores the function identifiers and the compute engine identifier of the compute engine. The client computing device uses the data structure to select a compute engine to which to send each function call raised by the plurality of user applications. After installation, each of the compute engines may send a message including the function identifiers and the compute engine identifier to the client computing device, which the client computing device uses to add the compute engine to the data structure.

The data structure may include a load indicator for each compute engine. In such embodiments, the client computing device updates the load indicator for the selected compute engine based at least in part on an amount of time a particular compute engine consumed executing a particular function. Further, each of the compute engines may periodically send a message including a load indicator to the client computing device. In such embodiments, the client computing device uses the message to update the load indicator stored in the data structure for the compute engine. The client computing device may detect the amount of time that elapses between successive periodic messages sent by a particular compute device, and if more than a predetermined amount of time elapses between successive messages, the client computing device deletes the compute engine from the data structure.

The system may be implemented using a data center having a plurality of networked computing devices. In such embodiments, an original library comprising the plurality of original functions that may be executed in parallel is received from the user and used to create a new library. The new library includes a new function corresponding to each original function. Then, function calls in the user application to the original functions in the original library are replaced with function calls to the new functions in the new library. Each original function may include executable object code and a function definition, which are used to create the corresponding new function. A plurality of compute engines (created using the original library) are installed on at least a portion of the plurality of networked computing devices of the data center. A number of compute engines in the plurality of compute engines may be determined by a licensing agreement.

The user application, which has been modified to call the new functions, may be received by the data center and executed by one of the networked computing devices of the data center. The data center may also receive input data for use by the user application. Alternatively, the user application may be executed by a computing device operated by the user.

### BRIEF DESCRIPTION OF THE SEVERAL VIEWS OF THE DRAWING(S)

FIG. 1 is a block diagram illustrating a system constructed according to aspects of the present invention.

FIG. 2 is a diagram of the hardware and operating environment in conjunction with which implementations of the system of FIG. 1 may be practiced.

FIG. 3 is a computer-readable medium storing computer executable modules implementing a client of the system of FIG. 1.

FIG. 4 is a computer-readable medium storing computer executable modules implementing a compute engine of the system of FIG. 1.

FIG. 5 is table illustrating information stored in a load balancing table used by the client of the system of FIG. 1.

FIG. 6 is table illustrating information stored in a compute request queue used by the client of the system of FIG. 1.

FIG. 7 is table illustrating information stored in a received compute request queue used by a compute engine of the system of FIG. 1.

FIG. 8 is a diagram of an embodiment of the system of FIG. 1 including multiple clients.

FIG. 9 is a flow diagram illustrating a method of configuring the system of FIG. 1 to execute a user application.

FIG. 10 is a flow diagram illustrating a method of using the system configured by the method FIG. 9 to execute the user application.

FIG. 11 is a diagram of an implementation of the system of FIG. 1 incorporating a data center.

### DETAILED DESCRIPTION OF THE INVENTION

### System Overview

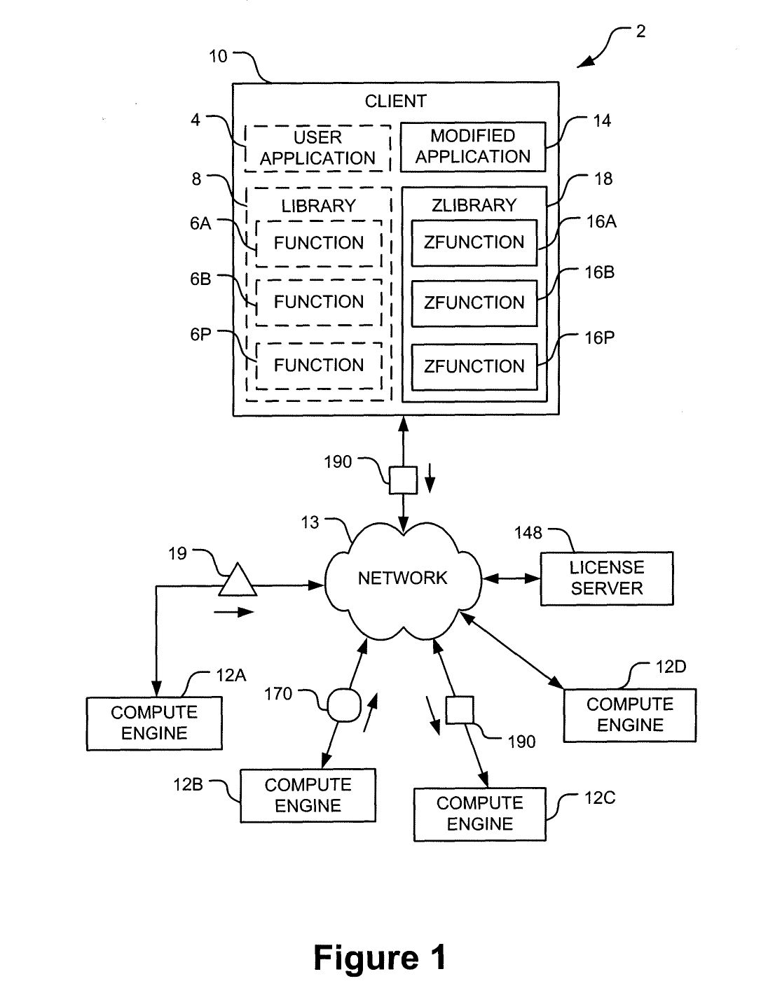

Referring to FIG. 1, aspects of the present invention relate to a system 2 for executing a user application 4 that calls functions (e.g., functions 6A, 6B, and 6P) at least a portion of which may be executed in parallel. The functions 6A, 6B, and 6P may reside in a library 8. Any method known in the art may be used to identify which functions called by the user application 4 may be executed in parallel during the execution of the user application 4, including a programmer of the user application 4 identifying the functions manually, a utility analyzing the code and automatically identifying the functions for parallel execution, and the like.

While the user application 4 is depicted in FIG. 1 as calling three functions 6A, 6B, and 6P, those of ordinary skill in the art appreciate that any number of functions may be called by the user application 4 and the invention is not limited to any particular number of functions. The user application 4 may be implemented in any manner known in the art including using C, C++, Java, and the like to write source code that is compiled into an executable application, using interpreted languages, such as Visual Basic, to call the functions 6A, 6B, and 6P, and using scripting languages executed by other applications such as Microsoft Excel, Microsoft Access, Oracle, SQL Server, and the like.

The system 2 includes a client 10 and one or more compute engines (e.g., compute engines 12A, 12B, 12C, and 12D). The client 10 is in communication with the compute engines 12A, 12B, 12C, and 12D. Optionally, the client 10 may be coupled to the compute engines by a network 13. The implementation of the system 2 excludes the intermediary server present in the prior art, which eliminates the single point of failure present in prior art systems and may facilitate higher throughput and performance.

When the user executes a modified application 14 created using the user application 4, the modified application 14 calls zfunctions 16A, 16B, and 16P created using functions 6A, 6B, and 6P, respectively. The zfunctions 16A, 16B, and 16P each identify the original functions 6A, 6B, and 6P, respectively. Each zfunction called by the modified application 14 informs the client 10 to instruct one or more of the compute engines 12A, 12B, 12C, and 12D to execute the function (function 6A, 6B, or 6P) corresponding to the zfunction called and to return a result 19 to the client 10. During the execution of the modified application 14, the client 10 manages the distribution of computation of the functions 6A, 6B, and 6P to the compute engines 12A, 12B, 12C, and 12D. The client 10 may communicate with the compute engines 12A, 12B, 12C, and 12D via any suitable protocol including TCP/IP, secure socket layer (“SSL”) protocol, and the like. While FIG. 1 depicts the system 2 as including four compute engines 12A, 12B, 12C, and 12D, those of ordinary skill in the art appreciate that any number of compute engines may be included and the invention is not limited to any particular number. In particular embodiments, the number of compute engines may be limited by a licensing agreement.

### Client 10

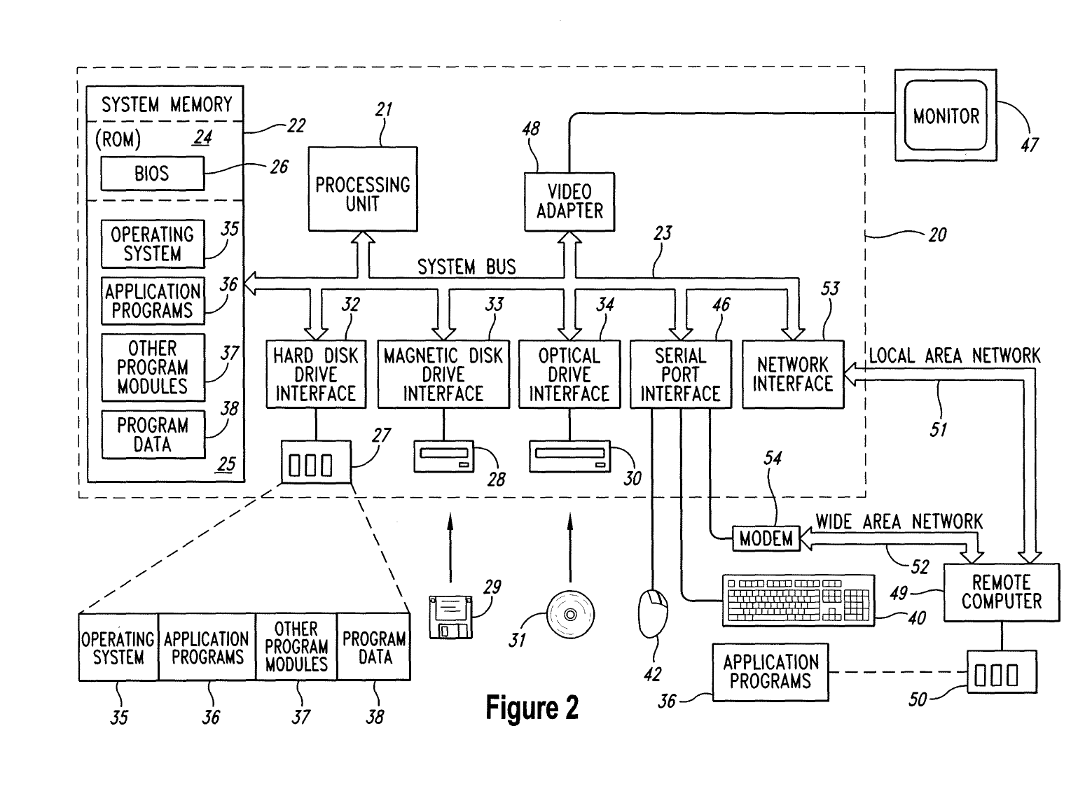

Referring to FIG. 2, the client 10 may be implemented on a computing device 20. FIG. 2 is a diagram of the hardware and operating environment in conjunction with which implementations of the system 2 may be practiced. The description of FIG. 2 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include function calls, routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 2 includes the computing device 20, which may be a general-purpose computing device of any type known in the art, including a processing unit 21, a system memory 22, and a system bus 23 that operatively couples various system components, including the system memory 22, to the processing unit 21. There may be only one or there may be more than one processing unit 21, such that the processor of computing device 20 comprises a single central-processing unit (CPU), or a plurality of processing units, commonly referred to as a parallel processing environment. The computing device 20 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 20, such as during start-up, is stored in ROM 24. The computing device 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 20. It should be appreciated by those skilled in the art that any type of computer-readable media, which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computing device 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computing device 20 may operate in a networked environment using logical connections to one or more remote computers, such as remote computer 49. These logical connections are achieved by a communication device coupled to or a part of the computing device 20 (as the local computer). Implementations are not limited to a particular type of communications device. The remote computer 49 may be another computing device substantially similar to computing device 20, a server, a router, a network PC, a client, a peer device or other common network node, and typically includes many or all of the elements described above relative to the computing device 20, although only a memory storage device 50 has been illustrated in FIG. 2. The logical connections depicted in FIG. 2 include a local-area network (LAN) 51 and a wide-area network (WAN) 52. Such networking environments are commonplace in offices, enterprise-wide computer networks, intranets, and the Internet. The network 13 (see FIG. 1) may include any of these networking environments.

When used in a LAN-networking environment, the computing device 20 is connected to the local network 51 through a network interface or adapter 53, which is one type of communications device. When used in a WAN-networking environment, the computing device 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 20, or portions thereof, may be stored in the remote memory storage device. It is appreciated that the network connections shown are exemplary and other means of and communications devices for establishing a communications link between the computers may be used.

The computing device 20 and related components have been presented herein by way of particular example and also by abstraction in order to facilitate a high-level view of concepts involved. The actual technical design and implementation may vary based on particular implementation while maintaining the overall nature of concepts disclosed.

### Client Program Modules

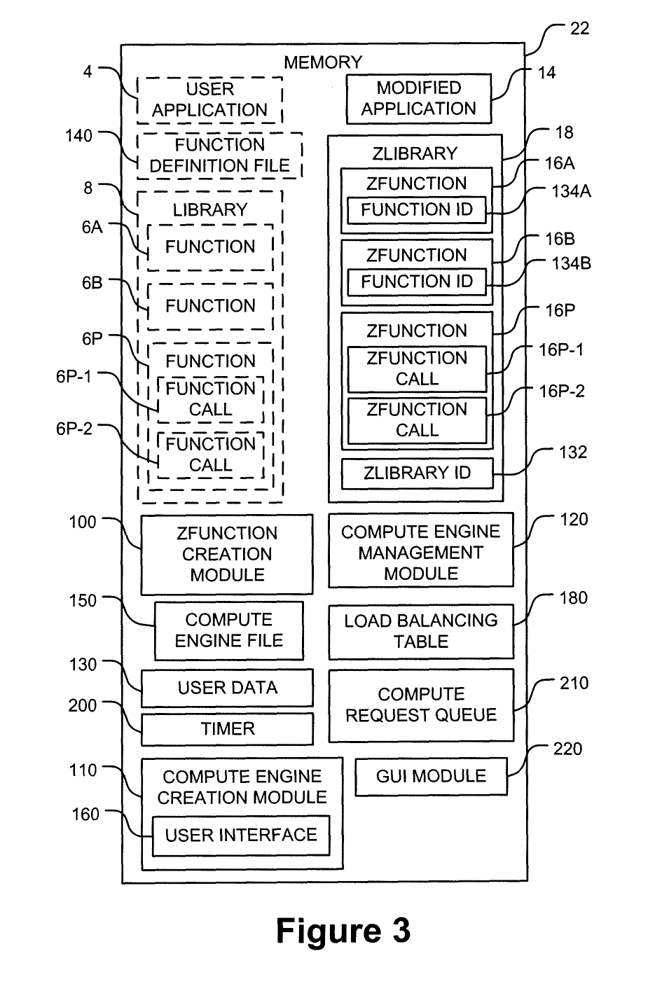

Referring to FIG. 3, an exemplary embodiment of the program modules stored in the memory 22 of the client 10 is provided. The client 10 may include three modules: (1) a zfunction creation module 100; (2) a compute engine creation module 110; and (3) a compute engine management module 120. Additionally, the memory 22 of the computing device 20 may store user data 130 for processing by the modified application 14.

### Zfunction Creation Module 100

As explained above, the user application 4 calls functions 6A, 6B, and 6P at least a portion of which may be executed in parallel. In the embodiment of the client 10 depicted in FIG. 2, the client 10 includes the zfunction creation module 100 including computer-executable instructions for using the functions 6A, 6B, and 6P called by the user application 4 to create the zfunctions 16A, 16B, and 16P. However, as is appreciated by those of ordinary skill in the art, the client 10 need not perform this function and another computing device may be used to create the zfunctions 16A, 16B, and 16P, which may subsequently be stored in the memory 22 of the client 10.

The zfunction creation module 100 uses the functions 6A, 6B, and 6P called by the user application 4 to create the zfunctions 16A, 16B, and 16P for each of the original functions 6A, 6B, and 6P, respectively. The zfunctions 16A, 16B, and 16P may be stored in the zlibrary 18 created by the zfunction creation module 100. In particular embodiments, the zfunction creation module 100 assigns a library identifier 132 to the zlibrary 18. The zfunction creation module 100 assigns a function identifier 134 to each zfunction 16A, 16B, and 16P, which is stored in the zfunctions, the zlibrary 18, or a combination thereof. For ease of illustration, only the function identifiers 134A and 134B stored by the zfunctions 16A and 16B, respectively, have been illustrated. However, as is appreciated by those of ordinary skill in the art, the other functions depicted also include the function identifier 134. Each zfunction includes a function call to its corresponding original function. Each of the zfunctions 16A, 16B, and 16P may be linked, either statically or dynamically, to its corresponding original function 6A, 6B, and 6P, respectively.

The function definitions of the zfunctions 16A, 16B, and 16P may include names that differ from those of the original functions 6A, 6B, and 6P. For example, the names of the zfunctions 16A, 16B, and 16P may be identical to the names of the original functions 6A, 6B, and 6P except the names of the zfunctions 16A, 16B, and 16P may be preceded by the letter “z.” In this example, if the function 6A is named “foo,” the corresponding zfunction 16A will be named “zfoo.” Because methods of renaming functions are well known in the art, an exhaustive list of renaming conventions will not be provided herein. Further, because implementing such methods requires only ordinary skill in the art, such methods are within the scope of the invention.

Each of the zfunctions 16A, 16B, and 16P includes instructions instructing the client 10 to select one of the compute engines 12 to execute the corresponding original function (instead of executing the original function itself as well as the function identifier 134 of the zfunction (linked to the original function). Because each of the zfunctions 16A, 16B, and 16P is linked to the corresponding original function 6A, 6B, and 6P, respectively, the zfunction creation module 100 need know only the function definition (i.e., function name, input parameters, and output parameters) of each original function to create a corresponding zfunction. In the embodiment depicted in the drawings, a function definition file 140 is provided by the user and stored in memory 22. The function definition file 140 includes a function definition for each of the original functions 6A, 6B, and 6P and is used by the zfunction creation module 100 to create the zfunctions 16A, 16B, and 16P. By way of non-limiting example, the function definition file 140 may include an XML file, a text file, and the like.

Because the zfunction creation module 100 need know only the function definition for each of the original functions 6A, 6B, and 6P, the user may supply object or compiled code for the functions 6A, 6B, and 6P instead of source code. By way of non-limiting example, the functions 6A, 6B, and 6P may reside in dynamic-link library (“DLL”) file, and the like. Because the user need not supply source code, the algorithms performed in each of the functions 6A, 6B, and 6P may remain confidential. This allows the user to use the system 2 to execute the user application 4 even if the user does not have the original source code to the functions 6A, 6B, and 6P in the library 8 (e.g., the user purchased an off-the-shelf application configured for parallel execution). Further, the developer of the library 8 may provide its purchasers with only the executable code and function definitions for the functions in the library, thereby maintaining the confidentiality of the algorithms executed.

After the zfunction creation module 100 has created the zfunctions 16A, 16B, and 16P and optionally, the zlibrary 18, the user modifies the user application 4 to create the modified application 14, which is configured to call the zfunctions 16A, 16B, and 16P instead of the original functions 6A, 6B, and 6P. This may require linking the user application 4 to the zlibrary 18, instead of the library 8. If the zfunctions 16A, 16B, and 16P have names that differ from the names of the original functions 6A, 6B, and 6P, the function calls in the user application 4 may be modified to use the names of the zfunctions 16A, 16B, and 16P. For example, if the name of the function 6A is “foo,” in the user application 4, the name “foo” is used to call the function 6A. In the modified application 14, the zfunction 16A, which is named “zfoo” is called instead of the function 6A. Therefore, to create the modified application 14, the user application 4 may be modified to replace the names of the original functions 6A, 6B, and 6P with the names of the corresponding zfunctions 16A, 16B, and 16P, respectively. However, as is appreciated by those of ordinary skill, other methods of modifying the user application 4 to replace calls to the original functions 6A, 6B, and 6P with calls to the zfunctions 16A, 16B, and 16P are known in the art and within the scope of the invention.

### Compute Engine Creation Module 110

In the embodiment of the client 10 depicted in FIG. 3, the client 10 includes a compute engine creation module 110 including computer-executable instructions for generating a single executable compute engine file 150. However, as is appreciated by those of ordinary skill in the art, the client 10 need not perform this function and another computing device may be used to generate the compute engine file 150. While a compute engine file 150 may optionally reside in the memory 22 of the client 10, this is not a requirement.

The compute engine creation module 110 may include an interface module 160 that allows the user to indicate on which platform (e.g., Windows NT, Linux, etc.) the compute engine file 150 should be configured to execute. Alternatively, the compute engine creation module 110 may be configured to generate more than one compute engine file 150. In such embodiments, the compute engine creation module 110 may generate an executable compute engine file 150 for a predetermined set of platforms. For example, the compute engine creation module 110 may generate a compute engine file configured for execution on a computing device running Windows NT and a compute engine file configured for execution on a computing device running Linux. Alternatively, the user may use the interface module 160 to select a set of platforms for which a compute engine file 150 will be generated. Exemplary platforms include Windows NT, Windows 2000, Windows XP, Windows Vista, Solaris 2.6+, Linux, and the like.

The system 2 may be implemented across more than one platform. In particular, the compute engines 12A, 12B, 12C, and 12D may be installed on more than one platform. For example, one or more compute engines 12 (e.g., engines 12A and 12B) may be installed on Linux systems, while one or more additional compute engines are installed on Windows NT systems (e.g., engines 12C and 12D). This may be accomplished by installing the appropriate compute engine file 150 on each platform to implement a compute engine 12A, 12B, 12C, or 12D on that platform. Further, the client 10 may be installed on a platform that differs from the platform on which one or more of the compute engines are installed. In other words, the system 2 may be implemented on heterogeneous platforms and hardware.

The compute engine creation module 110 uses the zlibrary 18 including the zfunctions 16A, 16B, and 16P (which are linked to the original functions 6A, 6B, and 6P, respectively) to create the compute engine file 150.

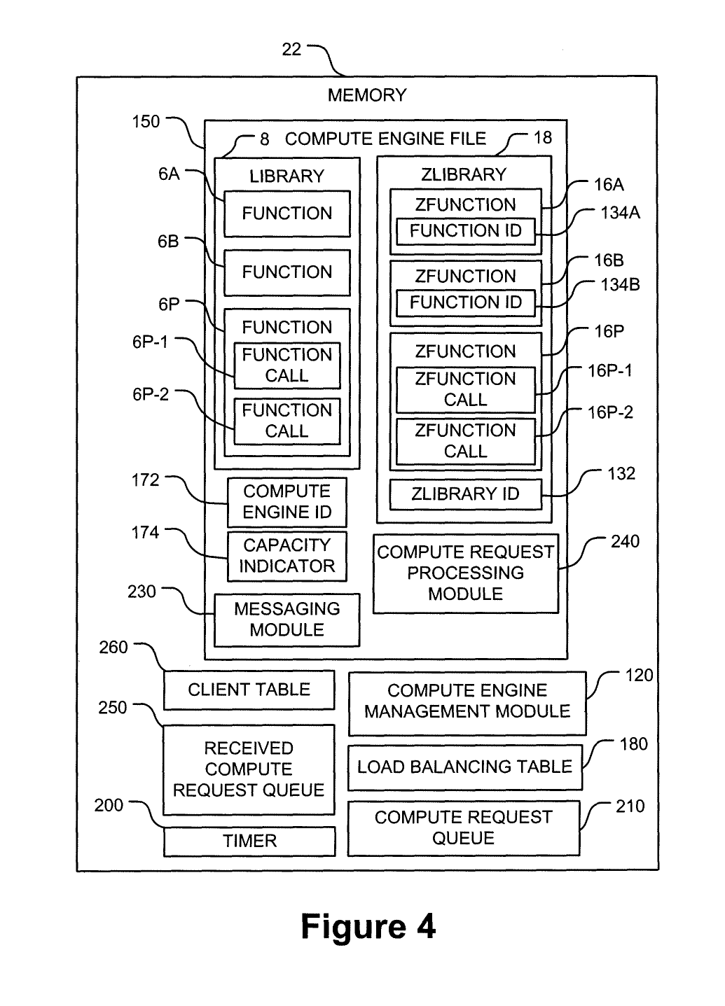

Referring to FIG. 4, the compute engine file 150 is depicted residing in the memory 22. The compute engine file 150 includes the executable code of the library 8 including the original functions 6A, 6B, and 6P and the zfunctions 16A, 16B, and 16P, which are linked to the original functions. The compute engine file 150 may include the library identifier 132 of the zlibrary 18 corresponding to the library 8. The compute engine file 150 includes the function identifier 134 assigned to each of the zfunctions. The function identifier 134 may be used to identify a particular zfunction, which is linked to a corresponding original function and thus used to identify the original function. Again, for ease of illustration, in FIG. 4, only the function identifiers 134A and 134B stored by the zfunctions 16A and 16B, respectively, have been illustrated. However, as is appreciated by those of ordinary skill in the art, the other functions depicted also include the function identifier 134.

The compute engine file 150 need not include any code from the user application 4 or the modified application 14. The compute engine file 150 may be used to execute the functions 6A, 6B, and 6P called by more than one user application, provided each user application is configured to call the zfunctions 16A, 16B, and 16P, instead of the original functions 6A, 6B, and 6P.

The executable compute engine file 150 may be copied and installed on any number of computing devices, such as a computing device identical or substantially similar to computing device 20. Once installed, the compute engine file 150 may be executed to implement a compute engine (e.g., compute engine 12A). More than one compute engine may be installed on a single computing device; each of the compute engines installed on the computing device may be executed by a separate thread by a single processing unit, as a separate process by different processors, or a combination thereof.

Returning to FIG. 1, once installed, the compute engines 12 (described in more detail below) transmit messages 170 announcing they are ready to receive compute requests from the compute engine management module 120 of the client 10. The messages 170 may be multicast messages sent over well-known multicast Internet protocol/port combinations (or channels) using any multicast transport protocol including without limitation User Datagram Protocol (“UDP”). The messages 170 may include a compute engine identifier 172 and a capacity indicator 174. The capacity indicator informs the compute engine management module 120, which is constantly monitoring the channel, about the available capacity of the compute engine. By way of non-limiting example, the capacity indicator may be expressed as a percentage. Immediately after being installed, a compute engine may provide a capacity indicator of 100% or alternatively, if the capacity indicator is a measure of load, instead of capacity, the capacity indicator may be zero (or zero percent), indicating the compute engine is experiencing zero load. The messages 170 may include the library identifier 132 of the zlibrary 18 created using the functions 6A, 6B, and 6P that the compute engine is configured to execute. The messages 170 may include the function identifiers 134 of the zfunctions 16A, 16B, and 16P the compute engine is configured to execute.

### Compute Engine Management Module 120

After the user has created the zfunctions 16A, 16B, and 16P, modified the user application 4 to call the zfunctions, created the compute engines 12A, 12B, 12C, and 12D, and installed the compute engines, the system 2 may complete any remaining setup automatically. As mentioned above, after a compute engine 12 is installed, it sends a message 170 to the client 10, which provides the client 10 with the compute engine identifier 172 and the capacity indicator 174 as well as any additional information required by the client 10 to communicate with the compute engine (e.g., network address) for the newly installed compute engine. In other words, the compute engines 12 announce themselves to the client 10, and the user need not provide a number of available compute engines 12 or an address of the available compute engines 12 on the network 13. The compute engine management module 120 may use each of the compute engine identifiers 172 to establish a point-to-point communication with each of the newly installed compute engines. The compute engine management module 120 may also register the client 10 with each of the compute engines 12 from which it receives a message 170 (discussed below).

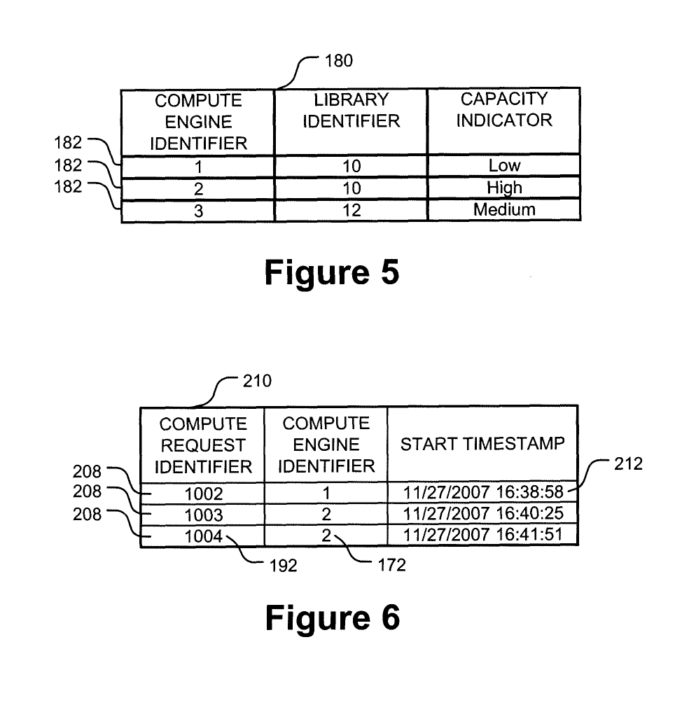

Referring to FIG. 5, the compute engine management module 120 uses the compute engine identifier 172 and the capacity indicator 174 to build a data structure such as a load balancing table 180. For each compute engine identifier received, the compute engine management module 120 adds a compute engine record 182 to the load balancing table 180 and records the available capacity of the compute engine. Initially, before the compute engines 12 have been instructed to execute any of the functions 6A, 6B, and 6P, the compute engines 12 report they have maximum capacity (i.e., none of the available capacity of the compute engines 12 is being consumed). The load balancing table 180 may store the library identifiers 132 of the compute engines. In some embodiments, the load balancing table 180 stores the function identifiers 134 of the zfunctions the compute engines are configured to execute.

New compute engines may be added to the load balancing table 180 at any time, including during the execution of the modified application 14 by the computing device 20 on which the client 10 is executing. Whenever a message 170 is received from a compute engine 12 not already included in the load balancing table 180, a new compute engine record 182 may be added. In this manner, one or more compute engines 12 may be added to a preexisting implementation of the system 2 on the fly.

Returning to FIGS. 1 and 3, the compute engine management module 120 includes computer executable instructions for configuring the processing unit 21 (see FIG. 2) to instruct one or more of the compute engines 12 to execute one or more of the functions 6A, 6B, and 6P. When the user executes the modified application 14 on the computing device 20, it begins calling the zfunctions in the zlibrary 18 in parallel according to the identification of functions that could be processed in parallel provided previously. Each of the zfunctions called alerts the compute engine management module 120 that a function call to a zfunction has occurred. In response to this alert, the compute engine management module 120 selects a compute engine 12 to which to send a compute request 190. The compute request 190 instructs the selected compute engine 12 to execute the original function corresponding to the zfunction that was called and provides any input parameter values need to execute the original function. The compute request 190 also instructs the selected compute engine to return the result 19 to the compute engine management module 120, which in turn, provides the result 19 to the modified application 14. Each compute request 190 may have a compute request identifier 192 (see FIG. 6).

The compute engine management module 120 uses the load balancing table 180 to select a compute engine 12 to which to send each compute request 190. After being alerted that a function call to a zfunction has occurred, the compute engine management module 120 selects the compute engine 12 in the load balancing table 180 configured to execute the function and having the largest available capacity indicated by the capacity indicator 174 to process a new compute request 190. Optionally, to avoid overloading the selected compute engine 12 with subsequent compute requests, the compute engine management module 120 may reduce the capacity indicator 174 of the selected compute engine 12 to reflect the fact that a new compute request 190 has been sent to the selected compute engine 12.

By way of non-limiting example, the capacity indicator 174 for each compute engine 12 stored in the load balancing table 180 may be expressed as a percentage. The client 10 may send a number of compute requests 190 to a particular compute engine that is directly proportional to its capacity (as indicted by its capacity indicator 174 in the load balancing table 180), which is inversely proportional to its current load. If the capacity indicator 174 of a particular compute engine indicates it has zero capacity, the client 10 may stop sending compute requests 190 to that particular compute engine.

If all capacity indicators 174 in the load balancing table 180 indicate zero capacity, the client 10 may wait until the capacity indicator 174 of a compute engine in the load balancing table 180 indicates a compute engine has a capacity greater than zero to send the next compute request 190. In some embodiments, if the load balancing table 180 is empty or indicates zero capacity available on all of the compute engines 12, the client 10 may direct the processing unit 21 to execute the functions 6A, 6B, and 6P called by the modified application 14 locally (i.e., on the computing device 20).

The above compute engine selection process may allow for uniform utilization and data distribution to compute engines running on various hardware platforms, performing under wide range of environments and scenarios, and employing multiple computation algorithms of different duration. This selection process may function well in fast networks where network latency is considered negligibly small compared to middleware throughput time and processing time.

After sending a compute request 190, the client 10 may initialize a timer 200. If the timer 200 indicates a predetermined timeout period has elapsed before a response to the compute request 190 is received, the compute request 190 may be considered to have expired. When a compute request 190 expires, the client 10 may determine a failure has occurred and may resend the compute request 190. The compute request 190 may be resent to the same compute engine or a different compute engine. The compute engine to which the compute request 190 is resent may be determined using the load balancing table 180 according to any method described above for selecting a compute engine from the load balancing table 180. A failure may be caused by various network failures, hardware failures, middleware failures, software failures, excessive network congestion, and the like.

In some embodiments, if a failure occurs, the load balancing table 180 is adjusted to reflect that the compute engine to which the compute request 190 was sent is no longer available or has zero capacity to receive compute requests 190. A particular compute engine may be deleted from the load balancing table 180 after a single failure or a predetermined number of failures occur.

Referring to FIG. 6, the compute engine management module 120 may store a record 208 for each compute request 190 in a data structure, such as a compute request queue 210. Each record 208 in the compute request queue 210 may include the compute request identifier 192, and a start timestamp 212, which indicates when the compute request 190 was sent to a selected compute engine 12, which optionally, may be identified in the compute request queue 210 by its compute engine identifier 172. Optionally, the compute request 190 may include the start timestamp 212. When a result 19 is received from a compute engine 12, the result 19 includes the compute request identifier 172, which is used to locate and delete the record 208 in the compute request queue 210. The start timestamp 212 of the record 208 located may be used to determine how long the compute engine spent processing the compute request 190. Optionally, the compute engine identifier 172 may be included in the result 19 received in response to the compute request 190. Also optionally, the start timestamp 212 may be included in the result 19 received in response to the compute request 190.

The compute engine management module 120 may use how long a compute engine 12 spent processing a particular compute request 190 to update the load balancing table 180. For example, if a particular compute engine 12 required more than a predetermined amount of time to process a compute request 190, the capacity indicator 174 of the compute engine stored in the load balancing table 180 may be reduced. Alternatively, if a particular compute engine 12 required less than a predetermined amount of time to process a compute request 190, the capacity indicator 174 of the compute engine stored in the load balancing table 180 may be increased. In this manner, the compute engine management module 120 may load the compute engines 12 in proportion to their performance, thus enabling substantially uniform processing on uneven hardware and networks. While a non-limiting example of a method of adjusting the capacity indicator 174 for a compute engine in the load balancing table 180 has been described, those of ordinary skill in the art appreciate that other methods of evaluating computing capacity and using that evaluation to adjust a capacity indicator are known in the art and the invention is not limited to the method described.

The modified application 14 calls the zfunctions in a predetermined order. The client 10 is alerted to the function calls in the predetermined order and subsequently sends the compute requests 190 in the predetermined order. The records 208 in the compute request queue 210 may be ordered according to the predetermined order in which the compute requests 190 where sent to the compute engines 12. If a result 19 sent in response to a compute request 190 is received out of order (i.e., early or ahead of a result 19 of a compute request 190 that was sent earlier), the compute engine management module 120 may store the early result 19 and not forward it to the modified application 14 until responses to all of the compute requests sent before the early result are received. In this manner, responses are forwarded to the modified application 14 in the predetermined order in which the compute requests were sent, thus enforcing a specific ordering.

The compute request queue 210 may use the start timestamps 212 of the records 208 to identify compute requests 190 that have been pending longer than the predetermined timeout period. Any such compute requests 190 may be considered to have expired. If expired compute requests 190 are identified, the compute request queue 210 may notify the compute engine management module 120 that the expired compute request 190 should be resent. The compute request queue 210 may evaluate the start timestamps 212 of the records 208 according to any method known in the art. For example, the compute request queue 210 may evaluate the start timestamps 212 of the records 208 each time a result 19 to a compute request 190 is received. Alternatively, the compute request queue 210 may evaluate the start timestamps 212 of the records 208 periodically (i.e., at the expiration of a predetermined wait period). By way of another example, each time a result 19 is received, the timer 200 may be initialized. If a predetermined wait period expires before another response is received, the compute request queue 210 may evaluate the start timestamps 212 of the records 208 to determine whether any have expired and should be resent.

The compute engine management module 120 may store all of the results 19 of the functions executed in parallel before sending the results to the modified application 14 (i.e., a synchronous implementation). Typically, a synchronous implementation is used to process a set of predefined data. Alternatively, the compute engine management module 120 may forward the results 19 of the functions executed as they are received (i.e., an asynchronous implementation) for processing by the modified application 14. Whether a synchronous process or an asynchronous process is used may be determined by the user (or developer) of the modified application 14. To enabling a synchronous processing, the compute engine management module 120 includes gap detection instructions that identify when all of the replies are received.

### Graphical User Interface Module 220

Returning to FIG. 3, optionally, the client 10 may include a graphical user interface (“GUI”) module 220 for generating a GUI that allows the user to visualizes information stored in the load balancing table 180, such as the compute engines 12 available, their current capacities (or capacity indicators), and the library 18 (or library indicator) containing functions each compute engine is configured to execute. Optionally, the GUI may allow the user to visualize the heartbeats of the compute engines 12 (described below). The GUI module 220 may generate a GUI that allows the user to visualize information stored in the compute request queue 210. For example, the GUI may allow the user to visualize the current distribution of compute request across the compute engines and statistics associated with the compute requests (e.g., oldest request, average age of the compute requests, and the like).

The GUI may allow the user to stop/suspend/resume operations of the system 2 of one or more of its subcomponents. For example, the GUI may allow the user to disable a selected compute engine 12, change the capacity of a selected compute engine 12, and the like.

### Compute Engines 12

As discussed above, a particular compute engine file 150 is stored in memory (such as memory 22) and executed by a processing unit (such as processing unit 21) to produce a particular compute engine 12. As is apparent those of ordinary skill in the art, more than one instance of the compute engine 12 may be executed using the particular compute engine file 150. Two or more of the instances may be executed by the same processing unit. Alternatively, each of the instances may be executed on a separate processing unit. The processing units may reside in the same machine, on different machines connected via a network, and the like. Each instance may be executed using any of the implementations discussed above as suitable for implementation of the client 10. In particular embodiments, a set of multiprocessing unit computers may be dedicated to the execution of the compute engines 12. For example, compute engines may be installed on these multiprocessing unit computers at a ratio of one compute engine per one to two processing units. Referring to FIG. 1, the number of compute engines 12 executing on the network 13 may be limited by a license server 148 (described below).

Referring to FIG. 4, the exemplary memory 22 storing computer-executable instructions for configuring the processing unit 21 to implement a compute engine 12 is provided. Apart from the zfunctions 16A, 16B, and 16P and the original functions 6A, 6B, and 6P, the compute engine file 150 has two modules: a messaging module 230 and a compute request processing module 240.

### Messaging Module 230

After installation of the compute engine 12, the messaging module 230 generates the message 170, which provides the client 10 with the compute engine identifier 172 and the capacity indicator 174 of the newly installed compute engine. The message 170 may include the library identifier 132 of the zlibrary 18. In some embodiments, the message 170 may include the function identifiers 134 of the zfunctions 16A, 16B, and 16P the compute engine is configured to execute.

The messaging module 230 may also send the message 170 periodically to the client 10 to provide updates to the load balancing table 180. These periodic messages 170 may also be used to determine the compute engine 12 sending them is still functioning properly.

The messaging module 230 also sends the result 19 of each compute request 190 processed to the client 10.

Compute Request Processing Module 240

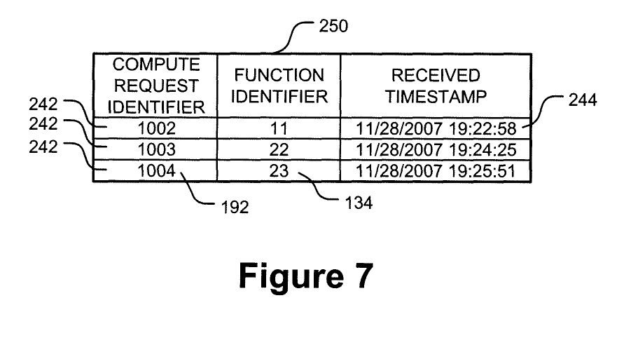

Referring to FIG. 7, the compute request processing module 240 receives each compute request 190 sent to the compute engine 12 and stores the compute request 190 in a new record 242 in a data structure such as a received compute request queue 250. The received compute request queue 250 may store the compute request identifier 192 of the compute request 190 and the function identifier 134 of the function to be executed in response to the compute request 190. The compute request processing module 240 may also store a received timestamp 244 for the compute request in the record 242. In embodiments in which the compute request 190 includes the start timestamp 212, optionally, the compute request processing module 240 may store the start timestamp for the compute request in the record 242.

The compute request processing module 240 selects a compute request 190 from the received compute request queue 250, executes the function 6A, 6B, or 6P identified by the function identifier 134 using any input parameters provided by the compute request 190. After the function 6A, 6B, or 6P has been processed, the compute request processing module 240 determines the capacity indicator 174 (i.e., capacity available on the compute engine 12 to process additional compute requests) and instructs the messaging module 230 to send the result 19 including the capacity indicator 174 to the client 10.

The compute request processing module 240 may determine the capacity available on the compute engine 12 using any method known in the art. The compute request processing module 240 may use how long a compute engine 12 spent processing the compute request 190 to determine the capacity indicator 174. For example, if a particular compute engine 12 required more than a predetermined amount of time to process a compute request 190, the capacity indicator 174 of the compute engine may be a first predetermined value. Alternatively, if a particular compute engine 12 required less than a predetermined amount of time to process a compute request 190, the capacity indicator 174 may be a second predetermined value. While a non-limiting example of a method of determining the capacity indicator 174 for a compute engine has been described, those of ordinary skill in the art appreciate that other methods of evaluating computing capacity and using that evaluation to determine a capacity indicator are known in the art and the invention is not limited to the method described.

The compute request processing module 240 may use the start timestamp 212 and the received timestamp 244 to calculate communication delays between the client 10 and the compute engine 12. The compute engine 12 may use the start timestamp 212 or the received timestamp 244 to determine one or more compute requests 190 have expired because too much time has elapse since they were sent or received, respectively. If the compute engine determines one or more compute requests 190 have expired, it can simply delete the expired compute requests. Further, if the compute engine 12 is able to process additional requests, the compute request processing module 240 may instruct the messaging module 230 to send a message 170 notifying the client 10 (and optionally, the other compute engines) of its status.

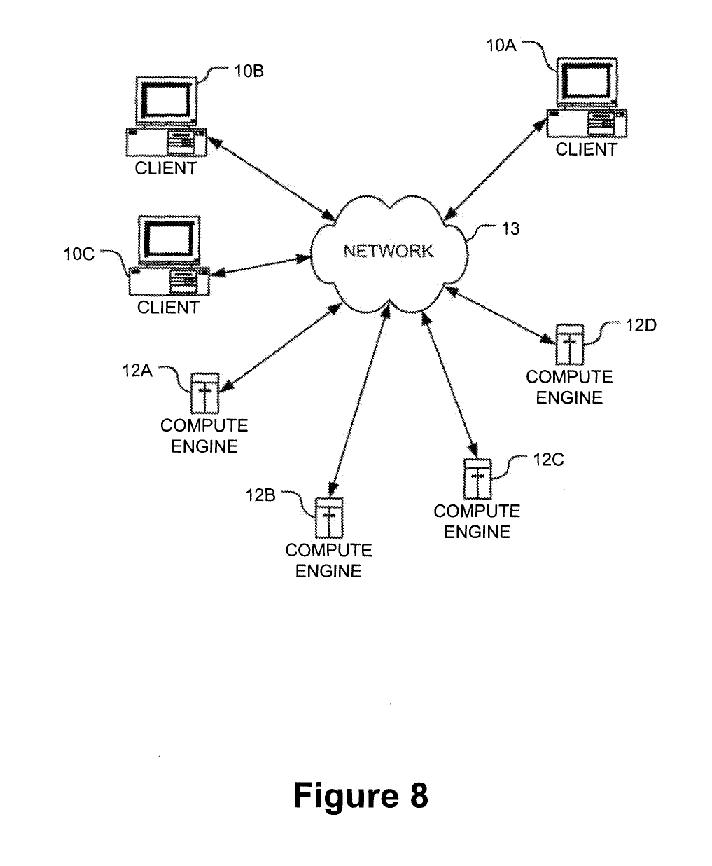

Referring to FIG. 8, while the embodiments of the system 2, discussed above, have described the system 2 as having a single client 10, as is appreciated by those of ordinary skill in the art, the system may have multiple clients 10A, 10B, and 10C each substantially similar to the client 10, and each of the compute engines 12 may process compute requests 190 from one or more of the clients 10A, 10B, and 10C. As is apparent to those of ordinary skill in the art, the clients 10A, 10B, and 10C may be executing the same modified application 14 or different applications that call zfunctions 16A, 16B, and 16P from the same zlibary 18.

In response to the receipt of a first message 170 from a particular compute engine 12, the client 10 may register with the compute engine 12. The clients 10A, 10B, and 10C registered with the compute engines 12A, 12B, 12C and 12D are stored in a data structure store in the memory 22, such as a client table 260 (see FIG. 4).

Further, while the compute engines 12 have been described as having been created by a single plurality of functions 6A, 6B, and 6P, those of ordinary skill appreciate that one or more compute engines may be created for additional pluralities of functions (not shown). Because the compute engines each include a library identifier and/or function identifiers, and such values may be stored in the load balancing table 180, only compute engines configured to execute a particular function will receive a compute request for that function.

### Cluster Functions

Referring to FIG. 4, as discussed above, each of the compute engines 12 includes a copy of the library 8 including the original functions 6A, 6B, and 6P. In particular embodiments, the compute engines 12 include an executable copy of the library 8 including the original functions 6A, 6B, and 6P. Each of the compute engines 12 is configured to receive a compute request 190 from the client 10. As discussed above, the compute request 190 identifies a particular function (e.g., the function 6A, 6B, or 6P) and provides values for each of the input parameters, if any, of the particular function.

Optionally, if a particular function 6P calls two or more functions 6P-1 and 6P-2 that may be executed in parallel (referred to as a “function cluster”), the compute engine 12 executing the function 6P may direct one or more other compute engines 12 to execute the functions 6P-1 and 6P-2. In such embodiments, the computer engines 12 may also include a copy of the compute engine management module 120 for managing requests sent to other compute engines. As described in detail above, the compute engine management module 120 may build and maintain two data structures, the load balancing table 180 and the compute request queue 210, both of which may be stored in the memory 22 of the computing device 20 executing the compute engine 12.

### License Server 148

Referring to FIG. 1, to limit the number of compute engines 12 for the purposes of license restrictions, before a compute engine sends a message 170 to the client 10, the compute engine must register with the license server 148. When the maximum number of compute engines 12 permitted by the license agreement have registered with the license server 148, the license server refuses to license any additional compute engines 12. During registration, the license server 148 may assign the compute engine identifier 172 to the compute engine 12. In this manner, no two compute engines 12 coupled to the network 13 will have the same compute engine identifier 172.

If a compute engine is disabled, the license server 148 may detect this and allow a new compute engine to register and thereby replace the disabled compute engine. The license server 148 may detect a compute engine has been disabled by detecting the disabled compute engine has stopped sending messages 170. Alternatively, the license server 148 may periodically send a message (not shown) to each compute engine 12 requesting its status. Methods of restricting the number of copies of a software program executed by one or more users are well known in the art and will not be described further.

If a compute engine 12 stops receiving compute requests 190, the compute engine 12 may have been deleted from the load balancing table 180 of the clients 10A, 10B, and 10C (see FIG. 8). Such a compute engine may reregister with the license server 148 to obtain a new compute engine identifier with which the compute engine 12 can resume processing compute requests 190. Alternatively, the compute engine 12 may be added to the load balancing table 180 the next time the compute engine 12 sends the message 170 to the client 10.

### Method of Configuring the System

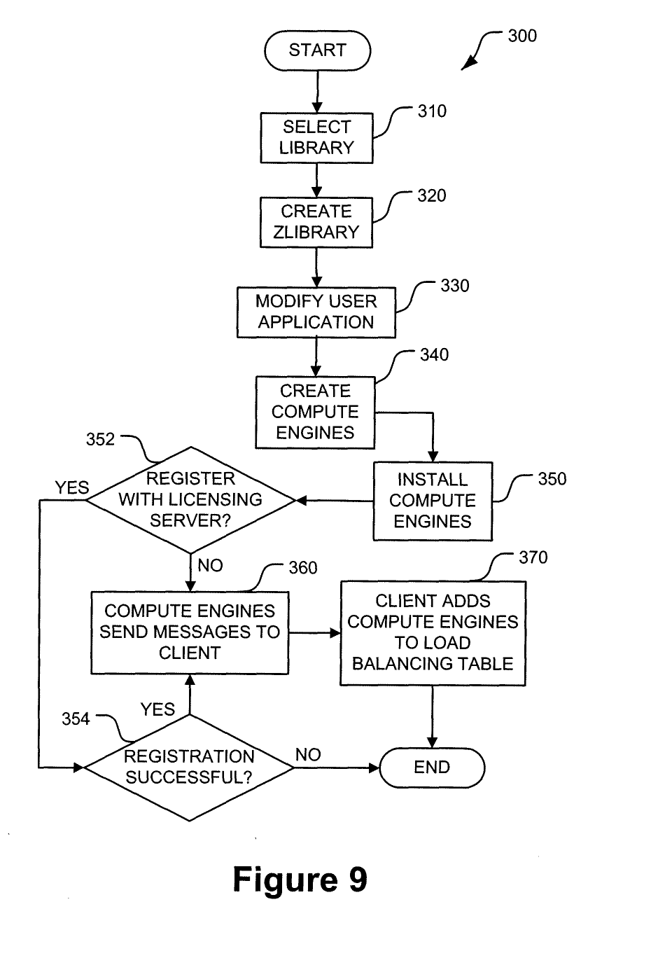

Referring to FIG. 9, aspects of the invention relate to a method 300 of configuring the system 2 to process the user application 4, which calls a plurality of original functions 6A, 6B, and 6P that may be executed in parallel. In block 310, the library 8 containing the functions 6A, 6B, and 6P called by the user application 4 is selected.

Then, in block 320, the library 8 is used to create the zlibrary 18. This may be performed by the zfunction creation module 100 (described above). In particular embodiments, in this block, a plurality of new functions (e.g., zfunctions 16A, 16B, and 16P) is created. Each of the new functions corresponds to one of the original functions and is configured such that when it is executed, it identifies the corresponding original function to the client 10 so that the client can generate a compute request 190 requesting processing of the original function by one of the compute engines.

In block 330, the user application 4 is modified (as described above) to create the modified application 14 in which each function call to an original function is replaced with a function call to the new function that corresponds to the original function.

In block 340, a plurality of compute engines are created using the library 8. This may be performed by the compute engine creation module 110 (described above). Each compute engine is configured to execute a requested original function in response to the compute request 190 sent by the client 10 and to send a result of the requested original function to the client.

In block 350, the plurality of compute engines are installed. Optionally, as described above, during installation the compute engines may be required to register with license server 148. If the compute engine must register with license server 148, the decision of decision block 352 is “YES” and the method 300 advances to decision block 354. Otherwise, the method 300 advances to block 360.

In decision block 354, whether registration is successful is determined. If registration is successful, the method 300 advances to block 360. Otherwise, the method 300 terminates.

After installation and optionally, registration with the license server 148, in block 360, each of the compute engines, sends a message 170 to the client(s) 10 coupled to the network 13 indicating the compute engine is available to receive a compute request.

In response to the receipt of the message 170, in block 370, the client 10 adds the compute engine to the load balancing table 180. This may be performed by the compute engine management module 120 (described above). At this point, the method 300 terminates. The system 2 is configured and ready to process the user application 14 modified in block 330.

### Method of Processing User Application on the System

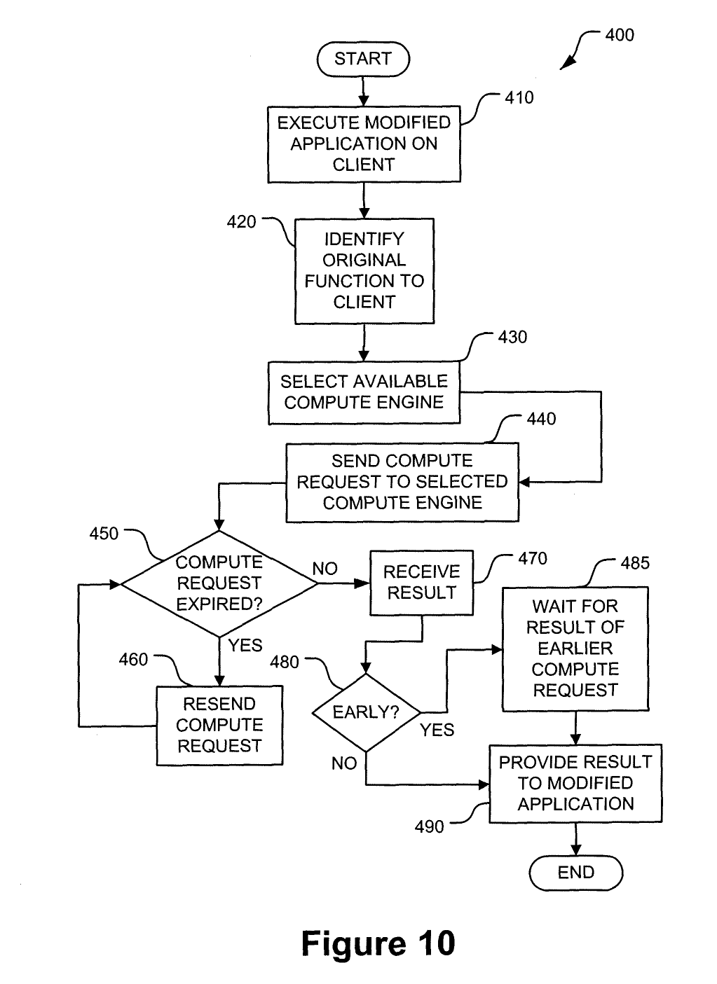

Referring to FIG. 10, after the system 2 has been configured by the method 300, the system may be used to perform a method 400 of executing the functions 6A, 6B, and 6P called by the user application 14 modified in block 330 in parallel.

In first block 410, the modified user application 14 is executed on the client computing device 20. During execution, the modified application 14 calls the new functions (e.g., zfunctions) created by the method 300. When called by the modified application 14, in block 420, each new function identifies its corresponding original function to the client 10. In response to the identification of the corresponding original function, in block 430, the client 10 selects a compute engine from among the compute engines that indicated they were available to receive a compute request in block 360 of the method 300.

In next block 440, the client 10 sends a compute request 190 to a compute engine that has indicated it is available to receive a compute request. This may be performed by the compute engine management module 120 (described above) using the load balancing table 180.

At this point, the client 10 monitors the compute request 190 to determine whether it has expired before the result 19 is received from the compute engine. If the compute request 190 expires, the decision in decision block 450 is “YES,” and the method 400 advances to block 460. In block 460, the compute request 190 is resent and the client resumes monitoring the compute request 190 to determine whether it has expired before the result 19 is received from the compute engine.

If the compute request 190 has not expired before the result is received in block 470, the decision in decision block 450 is “NO.” After the result 19 is received in block 470, a decision is made in decision block 480, whether the result 19 is early. If the decision is “YES,” the method 400 advances to block 485 whereat the method 400 waits for the result of an earlier compute request. Otherwise, if the decision is “NO,” the method 400 advances to block 490 whereat the result is provided to the modified application 14. As explained above, the result may be provided according to either a synchronous or an asynchronous implementation. Then, the method 400 terminates.

### Data Center Embodiment

Referring to FIG. 10, an exemplary embodiment of a data center 500 coupled to the network 13 is provided. One or more user computing devices 510 are also coupled to the network 13 for communication with the data center 500. The data center 500 includes a plurality of processors and/or computers coupled together and configured to execute software programs. The data center 500 may include a dynamic collection of various remote computing devices, possibly assembled using multiple physical data centers (not shown).

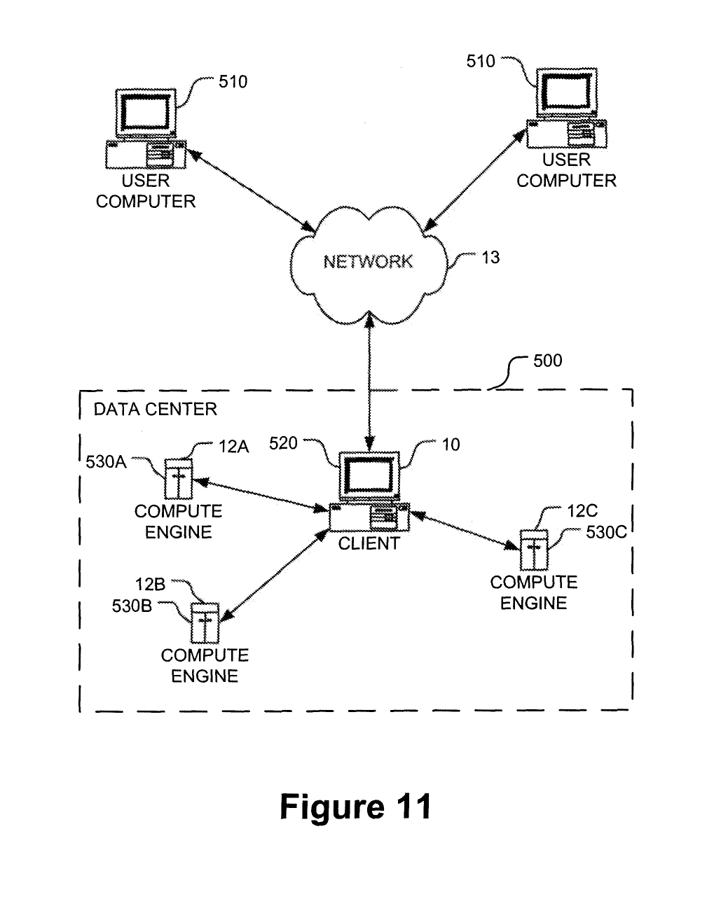

The data center 500 includes a computing device 520 (e.g., the computing device 20) configured as the client 10. The data center 500 also includes a computing device configured as a gateway or portal, such as a web portal, to the user computers 510. By way of non-limiting example, and for ease of illustration, in the embodiment depicted in FIG. 11, the computing device 520 provides the gateway; however this not a requirement.

The user may upload the library 8 and/or functions 6A, 6B, and 6P to the computing device 520, which may be used to create the zlibrary 18 and/or zfunctions 16A, 16B, and 16P as well as the compute engines 12A, 12B, and 12C. The compute engines 12A, 12B, and 12C are installed on one or more computing devices 530A, 530B, and 530C of the data center 500.

The user may then receive a copy of the zlibrary 18 and/or zfunctions 16A, 16B, and 16P, which the user may use to modify the user application 4 to create the modified application 14. By way of non-limiting example, the copy of the zlibrary 18 and/or zfunctions 16A, 16B, and 16P may be emailed to the user, send on computer-readable media via courier, downloaded by the user to the user computing device 510 from the data center 500, and the like. The user may use the user computing device 510, another computing device (not shown), one of the computing devices of the data center 500 (e.g., the computing device 520), and the like to modify the user application 4.

The user may then execute the modified application 14 locally on user computing device 510, sending compute requests to the compute engines 12A, 12B, and 12C over the network 13. Alternatively, the user may upload the modified application 14 to the data center 500 for execution on one of the computers of the data center 500.

The user may be billed for usage of the data center 500 based on the number of CPU hours consumed executing the modified application 14 on the compute engines 12A, 12B, and 12C. The number of compute engines 12A, 12B, and 12C installed on one or more computing devices 530A, 530B, and 530C of the data center 500 may be determined by a user or license agreement.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system for processing a user application having a plurality of functions identified for parallel execution, the system comprising:
a plurality of compute engines, each compute engine being configured to execute the plurality of functions and to execute a requested function of the plurality of functions in response to a compute request requesting execution of the requested function;
a client computing device coupled to the plurality of compute engines and having a memory storing the user application and a compute engine management module, and at least one processing unit configured to execute the user application and the compute engine management module,
during execution of the user application by the processing unit, the compute engine management module being configured:
to detect a function call to a called function of the plurality of functions,
to instruct the at least one processing unit to select a compute engine from the plurality of compute engines,
to send a compute request to the selected compute engine requesting that the selected compute engine execute the called function of the plurality of functions as the requested function,
to receive the result of the called function of the plurality of functions from the selected compute engine, and
to provide the result of the called function received from the selected compute engine to the user application.

2. The system of claim 1, wherein
each of the compute engines of the plurality of compute engines is configured to send a message to the client computing device informing the compute engine management module of the existence of the compute engine, and
in response to a message received from a compute engine, the compute engine management module is further configured to instruct the at least one processing unit to add a record for the compute engine to a data structure identifying compute engines of the plurality of compute engines available for processing compute requests,
wherein instructing the at least one processing unit to select the compute engine from the plurality of compute engines comprises instructing the at least one processing unit to select a compute engine from the data structure identifying compute engines of the plurality of compute engines available for processing compute requests.

3. The system of claim 2, wherein during execution of the user application by the processor, the compute engine management module is further configured:
to detect the compute request has expired by detecting a predetermined time period has elapsed since the compute request was sent to the selected compute engine and the result has not yet been received from the selected compute engine, and
if the compute request has expired, to instruct the at least one processing unit to select a different compute engine from the plurality of compute engines, to send a compute request to the different compute engine requesting that the different compute engine execute the called function of the plurality of functions as the requested function, to receive the result of the called function from the different compute engine, and to provide the result of the called function received from the different compute engine to the user application.

4. The system of claim 3, wherein during execution of the user application by the processor, if the compute request has expired, the compute engine management module is further configured to instruct the at least one processing unit to delete the record for the selected compute engine from the data structure identifying compute engines of the plurality of compute engines available for processing compute requests.

5. The system of claim 1, wherein the compute engine management module is further configured
to instruct the at least one processing unit to construct a load balancing table comprising a record for each compute engine in the plurality of compute engines, each record comprising a compute engine identifier and a capacity indicator indicating capacity available on the compute engine to process a new compute request, and
to update the record for the selected compute engine after the result of the called function is received based at least in part on an amount of time that elapsed between when the compute request was sent and when the result was received, and
wherein instructing the at least one processing unit to select the compute engine from the plurality of compute engines is based at least in part on the capacity indicators in the load balancing table for the plurality of compute engines.

6. The system of claim 1, wherein
each of the compute engines of the plurality of compute engines is configured to inform the compute engine management module of capacity available on the compute engine to process a new compute request, and
the compute engine management module instructs the at least one processing unit of the client computing device to select the compute engine from the plurality of compute engines based at least in part on the available capacity of the plurality of compute engines provided to the compute engine management module by each of the compute engines.

7. The system of claim 1, wherein during execution of the user application by the at least one processing unit, the user application makes function calls to the plurality of functions in a predetermined order, and during execution of the user application by the processing unit, the compute engine management module is further configured:
to determine whether the result of the called function was received ahead of a result of a previously called function in the predetermined order, and
to provide the result to the user application, if the result of the called function was received ahead of the result of the previously called function in the predetermined order, the compute engine management module being further configured to wait until the result of the previously called function in the predetermined order is received and to provide the result of the previously called function to the user application before providing the result of the called function to the user application.

8. A method of configuring a system to process a user application having a plurality of original functions that may be executed in parallel, the system comprising a client computing device configured to distribute functions to a plurality of compute engines for parallel execution thereby, the method comprising:
creating a plurality of new functions by creating a corresponding new function for each original function of the plurality of original functions, each new function identifying the corresponding original function to the client computing device for processing by one of the compute engines of the plurality of compute engines, the client computing device being configured to send a compute request to a selected compute engine after the new function identifies the corresponding original function to the client computing device;
modifying the user application to replace each function call to an original function of the plurality of original functions with a function call to a new function of the plurality of new functions;
creating the plurality of compute engines, each compute engine of the plurality of compute engines being configured to execute a requested one of the plurality of original functions in response to a compute request sent by the client computing device requesting execution of the requested one of the plurality of original functions and to send a result of the requested one of the plurality of original functions to the client computing device;
installing the plurality of compute engines; and
after installation, each compute engine of the plurality of compute engines, sending a message to the client computing device indicating the compute engine is available to receive a compute request.

9. A method of processing the modified user application on the system configured by the method of claim 8, the method of processing the modified user application comprising:
executing the modified user application on the client computing device;
during execution of the modified user application by the client computing device and after a new function has identified a corresponding original function to the client computing device for processing by one of the compute engines of the plurality of compute engines, sending a compute request to a compute engine that has indicated it is available to receive a compute request.

10. The method of claim 8, further comprising:
during installation of the plurality of compute engines, registering each of the compute engines of the plurality of compute engines with a license server, the license server being configured to allow a predetermined number of compute engines to register, and if more than the predetermined number of compute engines attempt to register with the license server, preventing installation of those compute engines.

11. The method of claim 8, wherein the plurality of original functions that may be executed in parallel are stored in a library, the method further comprising:
uploading the library to a remote computing device whereat the plurality of new functions and plurality of compute engines are created; and
uploading the modified user application to the client computing device, which is located remotely.

12. The method of claim 8, wherein each original function of the plurality of original functions comprises executable object code and a function definition, and creating the corresponding new function for each original function of the plurality of original functions comprises using the executable object code and the function definition to create the corresponding new function.

13. A method of enabling parallel processing of a user application at a data center comprising a plurality of networked computing devices, the method comprising:
receiving from the user, an original library comprising a plurality of original functions that may be executed in parallel;
creating a new library using the original library, the new library comprising a new function corresponding to each original function of the plurality of original functions;
replacing calls in the user application to the original functions in the original library with function calls to the new functions in the new library;
creating a plurality of compute engines, each compute engine being configured to execute a requested function in the original library in response to a compute request requesting execution of the requested function;
installing the plurality of compute engines on at least a portion of the plurality of networked computing devices of the data center;
executing the user application thereby calling the new functions in the new library, each call to one of the new functions generating a compute request for one of the compute engines of the plurality of compute engines;
in response to each compute request, the compute engine in receipt thereof, executing the original function corresponding to the new function that caused the generation of the compute request and returning a result to the user application.

14. The method of claim 13, further comprising receiving the user application, and executing the user application on at least one of the plurality of networked computing devices of the data center.

15. The method of claim 13, wherein a number of compute engines in the plurality of compute engines is determined by a licensing agreement.

16. The method of claim 13, further comprising receiving input data for use by the user application.

17. The method of claim 13, wherein each original function in the plurality of original functions in the original library comprises executable object code and a function definition, and creating the corresponding new function for each original function of the plurality of original functions comprises using the executable object code and the function definition to create the corresponding new function.

18. A parallel processing system comprising:
a plurality of libraries comprising a plurality of functions that may be executed in parallel, each library in the plurality having a different library identifier;
for each library in the plurality of libraries, a corresponding plurality of compute engines each having the library identifier of the library, each compute engine in the plurality of compute engines having a compute engine identifier and being configured to execute the functions in the library and return a result;
a client computing device executing a plurality of user applications, each of the user applications having function calls to one of the libraries in the plurality of libraries, the client computing device being configured to send each of the function calls to one of the compute engines in the plurality of compute engines corresponding to the library to which the function called belongs, the client computing device being further configured to receive the result returned by the compute engine to which the function call was sent;
the client computing device comprising a data structure storing for each compute engine, the library identifier and the compute engine identifier of the compute engine, the client computing device being configured to use the data structure to select a compute engine to which to send each function call raised by the plurality of user applications.

19. The system of claim 17, wherein after installation, each of the compute engines is configured to send a message to the client computing device, the message comprising the library identifier and the compute engine identifier of the compute engine and the client computing device is configured to receive the message sent by the compute engine and add the compute engine to the data structure.

20. The system of claim 17, wherein the data structure further comprises a load indicator for each compute engine and the client computing device is configured to update the load indicator for the selected compute engine based at least in part on an amount of time a particular compute engine consumed executing a particular function.

21. The system of claim 17, wherein the data structure further comprises a load indicator for each compute engine, each of the compute engines is configured to send a message to the client computing device periodically, the message comprising the compute engine identifier and a load indicator, and the client computing device is configured to receive the message sent by the compute engine and use the message to update the load indicator stored in the data structure for the compute engine.

22. The system of claim 17, wherein each of the compute engines is configured to send a message to the client computing device periodically, the message comprising the compute engine identifier,
the client computing device is configured to detect the amount of time that elapses between successive messages sent by a particular compute device, and
if more than a predetermined amount of time elapses between successive messages sent by a particular compute device, the client computing device is configured to delete the compute engine from the data structure.

23. A parallel processing system comprising:
a plurality of libraries comprising a plurality of functions that may be executed in parallel, each function in the plurality having a different function identifier;
for each library in the plurality of libraries, a corresponding plurality of compute engines each having the function identifiers of the functions in the library, each compute engine in the plurality of compute engines having a compute engine identifier and being configured to execute the functions in the library and return a result;
a client computing device executing a plurality of user applications, each of the user applications having function calls to one of the libraries in the plurality of libraries, the client computing device being configured to send each of the function calls to one of the compute engines in the plurality of compute engines corresponding to the library to which the function called belongs, the client computing device being further configured to receive the result returned by the compute engine to which the function call was sent;
the client computing device comprising a data structure storing for each compute engine, the function identifiers and the compute engine identifier of the compute engine, the client computing device being configured to use the data structure to select a compute engine to which to send each function call raised by the plurality of user applications.

24. The system of claim 17, wherein after installation, each of the compute engines is configured to send a message to the client computing device, the message comprising the function identifiers and the compute engine identifier of the compute engine and the client computing device is configured to receive the message sent by the compute engine and add the compute engine to the data structure.

25. The system of claim 17, wherein the data structure further comprises a load indicator for each compute engine and the client computing device is configured to update the load indicator for the selected compute engine based at least in part on an amount of time a particular compute engine consumed executing a particular function.

26. The system of claim 17, wherein the data structure further comprises a load indicator for each compute engine, each of the compute engines is configured to send a message to the client computing device periodically, the message comprising the compute engine identifier and a load indicator, and the client computing device is configured to receive the message sent by the compute engine and use the message to update the load indicator stored in the data structure for the compute engine.

27. The system of claim 17, wherein each of the compute engines is configured to send a message to the client computing device periodically, the message comprising the compute engine identifier,
the client computing device is configured to detect the amount of time that elapses between successive messages sent by a particular compute device, and
if more than a predetermined amount of time elapses between successive messages sent by a particular compute device, the client computing device is configured to delete the compute engine from the data structure.

28. A computer-readable medium comprising computer executable instructions for configuring a processing unit:
to create a plurality of new functions using a plurality of original functions configured for parallel execution, creating the plurality of new functions comprising creating a corresponding new function for each original function of the plurality of original functions, each new function identifying the corresponding original function; and
to create a plurality of compute engines using the plurality of original functions configured for parallel execution, each compute engine of the plurality of compute engines being configured:
to execute a requested one of the plurality of original functions in response to a compute request sent by a client computing device requesting execution of the requested one of the plurality of original functions,
to send a result of the requested one of the plurality of original functions to the client computing device,
to install on a computing device, and
after installation, to send a message to the client computing device indicating the compute engine is available to receive a compute request.

29. The method of claim 28, wherein each compute engine of the plurality of compute engines are further configured during installation, to register with a license server, the license server being configured to allow a predetermined number of compute engines to register, and if more than the predetermined number of compute engines attempt to register with the license server, preventing installation of those compute engines.

30. The method of claim 28, wherein each original function of the plurality of original functions comprises executable object code and a function definition, and creating the corresponding new function for each original function of the plurality of original functions comprises using the executable object code and the function definition to create the corresponding new function.

31. A computer-readable medium comprising computer executable instructions for configuring a processing unit:
to create a new library using an original library comprising a plurality of original functions that may be executed in parallel, the new library comprising a new function corresponding to each original function of the plurality of original functions;
to create a plurality of compute engines, each compute engine being configured to execute a requested function in the original library in response to a compute request requesting execution of the requested function; and
during execution of an application calling one of the new functions of the new library, to generate a compute request for one of the compute engines of the plurality of compute engines, the one of the compute engines of the plurality of compute engines being configured to return a result of the requested function.

32. The computer-readable medium of claim 31 wherein generate a compute request for one of the compute engines of the plurality of compute engines comprises selecting a compute engine from the plurality of compute engines.

33. The computer-readable medium of claim 31 wherein each compute engine is configured to install on a computing device, and after installation, to send a message to the client computing device indicating the compute engine is available to receive a compute request, the computer-readable medium further comprising computer executable instructions for configuring the processing unit:
to construct a data structure comprising the compute engines available to receive a compute request; and
to use the data structure to select the one of the compute engines of the plurality of compute engines.

34. The computer-readable medium of claim 31 further comprising computer executable instructions for configuring the processing unit to determine whether the compute request has expired and if it has expired, to resend the compute request to a different one of the compute engines of the plurality of compute engines.

35. The computer-readable medium of claim 31 wherein each compute engine is configured to install on a computing device, and after installation, to send a message to the client computing device indicating the compute engine is available to receive a compute request and providing a capacity indicator, the computer-readable medium further comprising computer executable instructions for configuring the processing unit:
to construct a data structure comprising the compute engines available to receive a compute request and the capacity indicator for each available compute engine;
to use the data structure to determine which of the plurality of compute engines has with the greatest available capacity; and
to select the compute engine with the greatest available capacity as the one of the compute engines for which to generate the compute request.

36. The computer-readable medium of claim 31 further comprising computer executable instructions for configuring the plurality of compute engines to determine a capacity indicator and to include the capacity indicator in the result returned by the one of the compute engines.
